(19) United States
(12) Patent Application Publication
(10) Pub. No.: US 2005/0210041 A1
(43) Pub. Date: Sep. 22, 2005

(54) Management method for data retention

(75) Inventor: Yuichi Taguchi, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/804,618

(22) Filed: Mar. 18, 2004

(51) Int. Cl. G06F 17/00

(52) U.S. Cl. 707/100

(57) ABSTRACT

A storage system includes a host configured to receive a data file from a client, the host including a data management rule set program that is operable to associate a management rule to the data file received from the client. A first storage subsystem is configured to receive and store the data file from the host, the storage system including a storage controller and a plurality of storage volumes. A data protection server includes a data protection management program that cooperates with the first storage subsystem to protect the data file stored in the first storage subsystem.

### BACKGROUND OF THE INVENTION

The present invention relates to managing data stored in a storage system for data retention purposes.

Data archival or retention is the act of saving a specific version of a data set (e.g., for record retention purposes) for an extended period of time. The data set is stored in archive storage pursuant to command by a user or data processing administrator. Archived data sets are often preserved for legal purposes or for other reasons of importance to the data processing enterprise. Accordingly, it should be possible to verify that the archived data have not be altered, tempered, or rewritten once the data have been written. One method for providing data verification or certification is to use Write Once and Read Many (WORM) techniques.

As the term suggest, the WORM technique enables data to be written only once to the storage medium, e.g., optical storage device or WORM discs. Such WORM discs generally can be written only once because the medium is physically and permanently modified by the process of writing data thereto, e.g., by using a high power laser beam to form small pits which alter the reflectance of the surface of the medium. The read process can then retrieve the stored information many times thereafter by beaming a low power beam on the medium and detecting the reflectance of the low power beam.

The WORM technique has gained more importance recently with the new government regulations requiring companies to preserve certain business records in a non-rewritable, non-erasable format. For example, U.S. Securities and Exchange Commission has recently required stock brokers to preserve records of communications with their customers in a non-rewritable, non-erasable format under the Securities Exchange Act of 1934 Rule 17a-4. The National Association of Securities Dealers Inc. (NASD) has implemented similar regulations in Rule 3010 & 3110. These communications include emails, instant messages and voice messages, and constitute a tremendous amount of data.

One method of providing WORM storage procedure is to use File System's change mode functions like “chmod” in UNIX, which designates certain files as being non-rewritable. However, this method does not provide sufficient trusts to auditor since it is based on generally available software. The method also requires a significant administrative burden to users, such as changing modes to each file. Alternatively, WORM storage devices, e.g., CD-ROM and DVD-ROM, may be used. However, these WORM devices generally do not provide high speed write operations.

Storage manufacturers and service providers are starting to propose new storage solutions and technologies that would comply with the regulations and that would enable long term data retention over rewritable disk storage array infrastructure. Each solution has its own storage system and data management mechanism.

However, these solutions are not standardized and have different data management frameworks. The resulting incompatibility causes a problem when a customer tries to transfer a data retention system to another system provided by a different manufacturer or vendor. The problem also arises when a customer tries to use different services together at the same time.

The “solution-A” provided by “vendor-A” has its own data management framework and a data management rule DB that maintains the data retention period and other attribute parameters. The data files are preserved and relocated to adaptive assets, drives and media as defined on the data management rule DB. However, this data management rules are referable and controllable only within the “vendor-A” solutions. To install “vendor-B” solution, customers have to transfer and share the data management rules defined by “solution-A” into/with “solution-B,” which generally is not possible because the data management frameworks are not standardized and thus incompatible.

Furthermore, these two solutions may create inconsistent data management rules. For example, “solution-A” may set a retention period of “file-A” as “3 years”, while “solution-B” may set the same kind of rule as “5 years”. This type of conflict results in serious data management problems. Accordingly, a data management rule or method that is independent of vendor-oriented specifications and may be used with different data retention systems is needed.

### BRIEF SUMMARY OF THE INVENTION

The present invention relates to a data management method that enables data retention and relocation within a storage system. An embodiment of the present invention proposes a data management method to preserve business data over one or more storage systems. An administrator inserts data management rules into data files so that data management policy can be commoditized across multiple services. For example, a retention period rule for a data file can be shared by multiple servers.

To address this issue, the embodiment discloses a common data management mechanism that does not create solution dependent DBs that store data management rules that are available only within a given system solution. The data management rule information is stored inside of the data file directly (or attached thereto). In one implementation, the data management rules are included in the header of the data file.

One or more data management servers refer to the rules embedded in the header in order to determine how to protect and relocate the data. Once this method is implemented, the data management policy across different vendor frameworks can be commoditized.

To implement this method, the data management rule set program controls the data management policy rules of the data files. An administrator or module embeds the rules into a data file header using the rule set program. Once the rule parameters have been set, the data are managed as defined by the rules. The data management servers, e.g., the data protection server and data relocation server, understand the data management policy and manage the data accordingly.

In one embodiment, a storage system includes a host configured to receive a data file from a client, the host including a data management rule set program that is operable to associate a management rule to the data file received from the client. A first storage subsystem is configured to receive and store the data file from the host, the storage system including a storage controller and a plurality of storage volumes. A data protection server includes a data protection management program that cooperates with the first storage subsystem to protect the data file stored in the first storage subsystem.

In one embodiment, a management server is provided in a storage system, the storage system including one or more hosts and one or more storage subsystems. The management server comprises a memory to store data; a processor to process data; a network interface to link with one or more computers of the storage system; a first management program to attach a management rule to a data file to be stored in a storage subsystem of the storage system, the management rule relating to a retention period or relocation information of the data file, wherein the data file and the management rule are stored in a storage volume of the storage subsystem.

In another embodiment, a management server is provided in a storage system, the storage system including one or more hosts and one or more storage subsystems. The management server comprises a memory to store data; a processor to process data; a network interface to link with one or more computers of the storage system; a first management program operable to access a header of a data file and manage the data file according to a management rule inserted in the header, the management rule relating to a retention period or relocation instructions of the data file.

Yet another embodiment relates to a method for managing a data file stored in a storage system, the storage system including one or more client, one or more hosts, one or more storage subsystems. The method comprises receiving a data file including a header and a data content; attaching a management rule to the data file; storing the data file and the management rule at a first storage location in a first storage subsystem, the management rule relating to retention or relocation information of the data file; and notifying a management program about the data file.

As used herein, the term “storage system” refers to a computer system configured to store data and includes one or more storage units or storage subsystems, e.g., disk array units. Accordingly, the storage system may refer to a computer system including one or more hosts and one or more storage subsystems, or only a storage subsystem or unit, or a plurality of storage subsystems or units coupled to a plurality of hosts via a communication link. A storage system may also refer to a computer system having one or more clients, one or more hosts, and one or more storage subsystems configured to store data.

As used herein, the term, “storage subsystem” refers to a computer system that is configured to storage data and includes a storage area and a storage controller for handing requests from one or more hosts. The storage subsystem may be referred to as a storage device, storage unit, storage apparatus, or the like. An example of the storage subsystem is a disk array unit.

As used herein, the term “host” refers to a computer system that is coupled to one or more storage systems or storage subsystems and is configured to send requests to the storage systems or storage subsystems. The host may perform the functions of a server or client.

As used herein, the term “management rule” refers to information that relates to the retention period and/or relocation of data have been stored in or are to be stored in a storage subsystem. The management rule includes information relating to the retention period of the data associated with the management rule, the location whereon the data are to be stored, the type of storage device whereon the data are to be stored, or the type of storage media whereon the data are to be stored, or a combination thereof.

### BRIEF DESCRIPTION OF THE DRAWINGS

FIG. 1 illustrates a problem associated with using conflicting data retention systems.

FIG. 2 illustrates a storage system according to one embodiment of the present invention.

FIG. 3 illustrates a storage subsystem according to one embodiment of the present invention.

FIG. 4A illustrates a storage system having a plurality of software components used to implement a data retention method according to one embodiment of the present invention.

FIG. 4B illustrates a storage system having a plurality of software components used to implement a data retention method according to another embodiment of the present invention.

FIG. 5 illustrates an exemplary computer system that may represent the client, host, data protection server, and data relocation server.

FIG. 6 illustrates the data structure of a data file according to one embodiment of the present invention.

FIG. 7 illustrates a graph user interface (GUI) presented by the data management rule set GUI according to one embodiment of the present invention.

FIG. 8 illustrates a table that corresponds to the data management rule information according to one embodiment of the present invention.

FIG. 9 illustrates a table corresponding to the storage information table according to one embodiment of the present invention.

FIG. 10 illustrates a user interface for obtaining the table according to one embodiment of the present invention.

FIG. 11 illustrates a process for creating an application data file according to one embodiment of the present invention.

FIG. 12 illustrates a process performed by the data protection server according to one embodiment of the present invention.

FIG. 13 is a process for relocating data files according to one embodiment of the present invention.

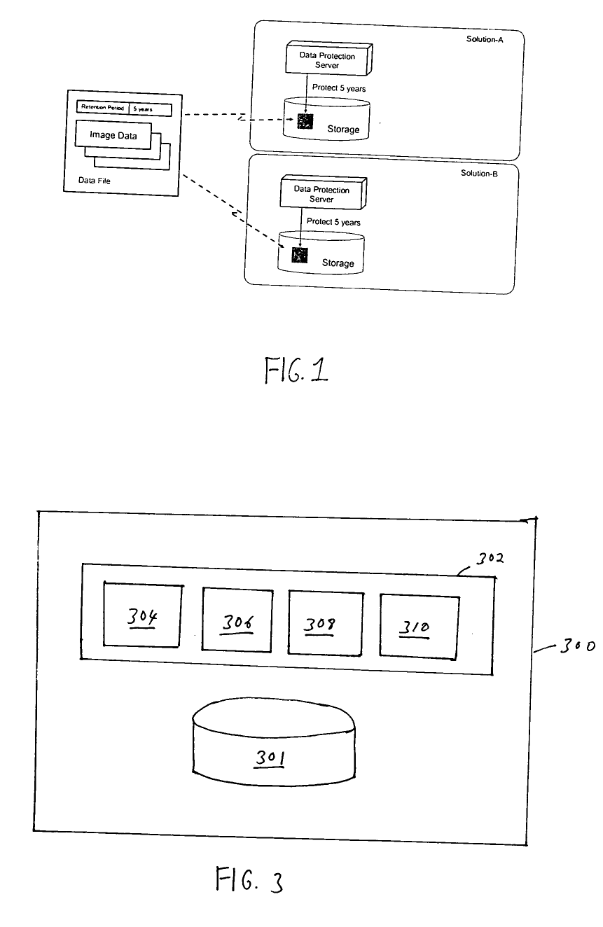

### DETAILED DESCRIPTION OF THE INVENTION

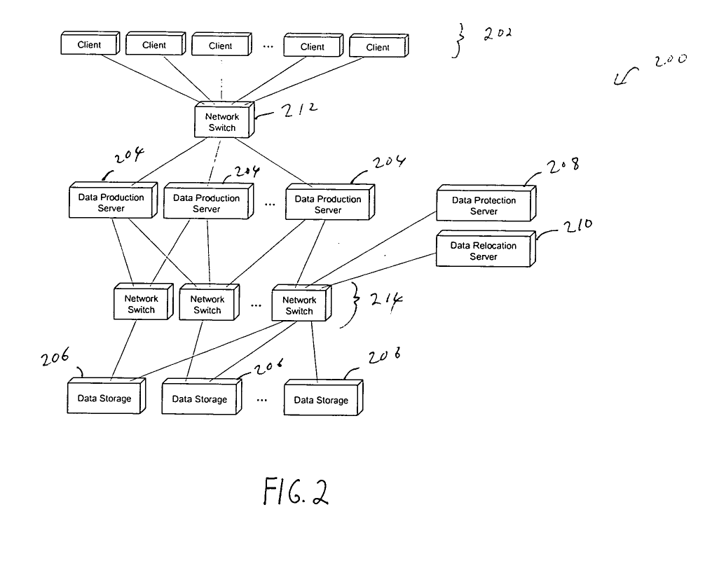

FIG. 2 illustrates a storage system 200 according to one embodiment of the present invention. The storage system 200 includes a plurality of clients 202, a plurality of hosts or data production servers 204, a plurality of storage subsystems or data storage devices 206, a data protection server 208, and a data relocation server 210. The clients 202 are coupled to the hosts 204 via a network 212, e.g., a wide area network. The hosts are coupled to the storage subsystems 206 via a network 214, e.g., a storage area network (SAN).

A SAN is a network that is used to link one or more storage subsystems to one or more hosts. The SAN commonly uses one or more Fibre Channel network switches that connect the hosts (data production server) and storage subsystems (data storage) together. An example of the storage subsystem is a disk storage array device.

The host is configured to receive read and write requests from the clients. The clients create information data using an application program provided by the hosts. This client-server system includes network switches that provide data link between the clients and hosts/servers. In one embodiment, the network 212 is a conventional IP network.

The host is configured to issue I/O request to the storage subsystem in order to read or store data to the storage subsystem. The I/O requests correspond to the read/write requests of the clients. The subsystem includes a plurality of disk drives to store the data files. Generally, these disk drives define a plurality of storage volumes wherein the data files are stored. In one embodiment, the network 214 is an IP network and does not use Fibre Channel switches.

FIG. 3 illustrates a storage subsystem 300 according to one embodiment of the present invention. The storage subsystem includes a storage controller 302 configured to handle data read/write requests and a storage unit 303 including a recording medium for storing data in accordance with write requests. The controller 302 includes a host channel adapter 304 coupled to a host (e.g., host 204), a subsystem channel adapter 306 coupled to another subsystem (e.g., one of the storage subsystems 206), and a disk adapter 308 coupled to the storage unit 303 in the storage subsystem 300. In the present embodiment, each of these adapters includes a port (not shown) to send/receive data and a microprocessor (not shown) to control the data transfers via the port.

The controller 302 also includes a cache memory 310 used to temporarily store data read from or to be written to the storage unit 303. In one implementation, the storage unit is a plurality of magnetic disk drives (not shown).

The subsystem provides a plurality of logical volumes as storage areas (or storage volumes) for the host computers. The host computers use the identifiers of these logical volumes to read data from or write data to the storage subsystem. The identifiers of the logical volumes are referred to as Logical Unit Numbers (“LUNs”). The logical volume may be defined on a single physical storage device or a plurality of storage devices. Similarly, a plurality of logical volumes may be associated with a single physical storage device. A more detailed description of storage subsystems is provided in U.S. patent application Ser. No. ______, entitled “Data Storage Subsystem,” filed on Mar. 21, 2003, claiming priority to Japanese Patent Application No. 2002-163705, filed on Jun. 5, 2002, assigned to the present Assignee, which is incorporated by reference.

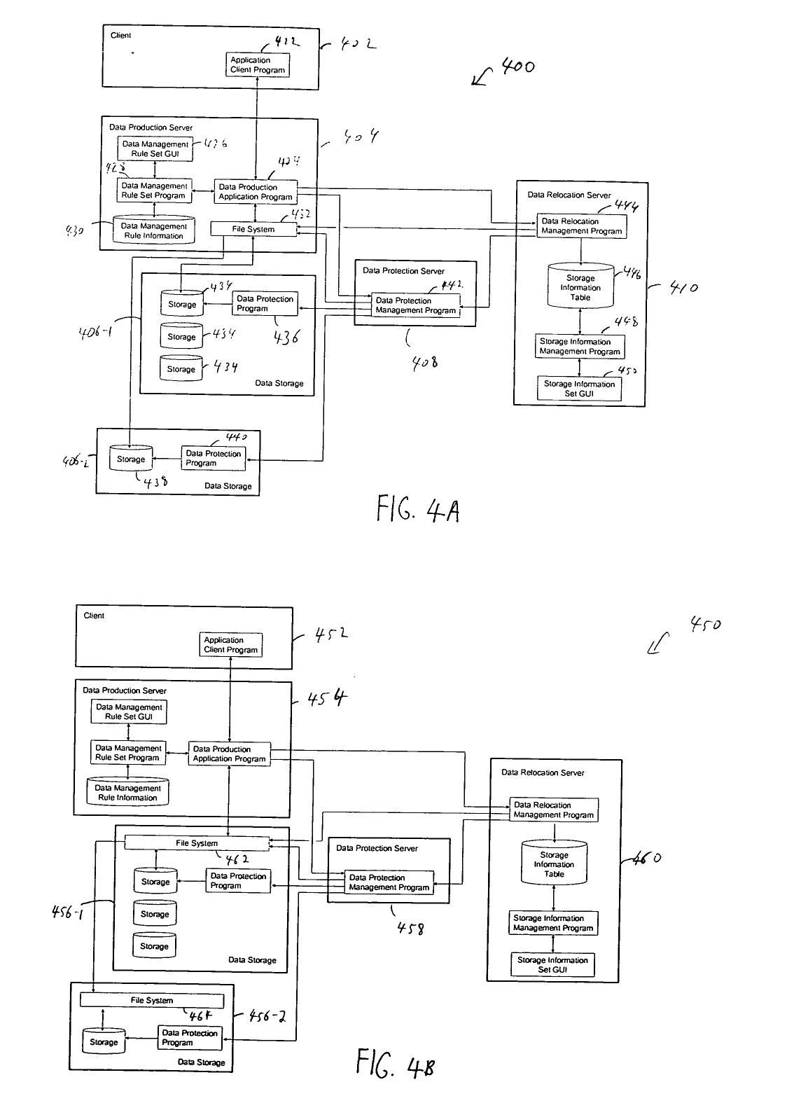

FIG. 4A illustrates a storage system 400 having a plurality of software components used to implement a data retention method according to one embodiment of the present invention. The storage subsystem includes a client 402, a host or data production server 404, a first storage subsystem 406-1, a second storage subsystem 406-2, a data protection server 408, and a data relocation server 410. The storage system 400 corresponds to the storage system 200. That is, the system 400 may include a plurality of clients 402 and hosts 404 although only one of each is shown.

The client 402 includes an application client program 422 that works as an interface to input application data. Data files to be stored are created by this program. The application client program generates I/O request to the host or data production servers. In one implementation, the database client program (not shown) may serve as the application client program.

The host 404 runs a data production application program 424 that interfaces with the application client program 422. In one implementation, conventional database applications, such as those of Oracle, can work the data production application program 424. A data management rule set GUI 426 is used to insert data management rules into the data file header. The program 426 provides a graphic user interface (GUI) so that an administrator may input the rules manually. In one implementation, this program may be a plug-in program of the database application. A data management rule set program 428 embeds the rules to a header of the data file. A data management rule information 430 is a local data store that stores user defined rules. The management rule information 430 may include predetermined default rules for certain applications or rules that have been manually entered by an administrator using the rule set GUI 426. A file system 432 processes data to be stored in the storage subsystems and interfaces with the subsystems 406-1 and 406-2, data protection server 408, and data relocation server 410. The file system 432 may include access information for the data files stored in the storage subsystems, so that certain data files may be protected and prevented from being modified, i.e., only grant READ access to the protected data files.

The first storage subsystem 406-1 (or data storage) includes a plurality of storage media 434 wherein the write data received from the host are stored. The storage media 434 are volumes defined on a plurality of disk drives within the storage subsystem according to one embodiment of the present invention. In other implementations, the storage media 434 may be tape devices or other types of storage devices. The first subsystem 406-1 includes a data protection program 436 for restricting overwriting of data files stored in the storage media or volumes 434. For example, the program 436 may lock the storage volumes and prohibit new creation, modification and deletion of data in the storage volume. Hitachi LDEV Guard™ function may be used as the program 436 in one implementation. Similarly, the second storage subsystem 406-2 includes a storage volume 438 and a data protection program 440.

The data protection server 408 is a data management server that is used to protect data files stored in the subsystems. In one embodiment, the server 408 is a host computer dedicated for this purpose. In one another embodiment, the server 408 may also function as a host computer, e.g., host 404, to the client 402. A data protection management program 442 is installed in the server 408.

The data relocation server 410 controls the relocation of data files stored in the storage subsystems. A data relocation management program 444 is used to relocated data files stored in a given subsystem to another subsystem. The program 444 interfaces with the data production application program 424 of the host for this purpose. A storage information table 446 includes information about the storage subsystems installed for the storage system 200, e.g., the name of the storage subsystem, the address, asset type, and storage media type. A storage information management program 448 is used to collect information to be included in the table 446. A storage information set GUI 450 enables an administrator to input information for the table 446.

FIG. 4B illustrates a storage system 450 having a plurality of software components used to implement a data retention method according to another embodiment of the present invention. In the storage system 450, the storage subsystems are Network Attached Storages (NAS). A NAS is a storage subsystem that is equipped with a file system to process data files received from the host. The storage system 450 includes a client 452, a host 454, a first subsystem 456-1, a second subsystem 456-2, a data protection server 458, and a data relocation server 460. These devices correspond to those of the system 400 of FIG. 4A. One different is that the subsystems 456-1 and 456-2 have file systems 462 and 464, respectively, to handle data files received from the host 454 and store the data received from the host as files. In one embodiment, the data protection server and the data relocation server are the same server. In another embodiment, a given host 404 also performs the functions of the data protection server and/or the data relocation server.

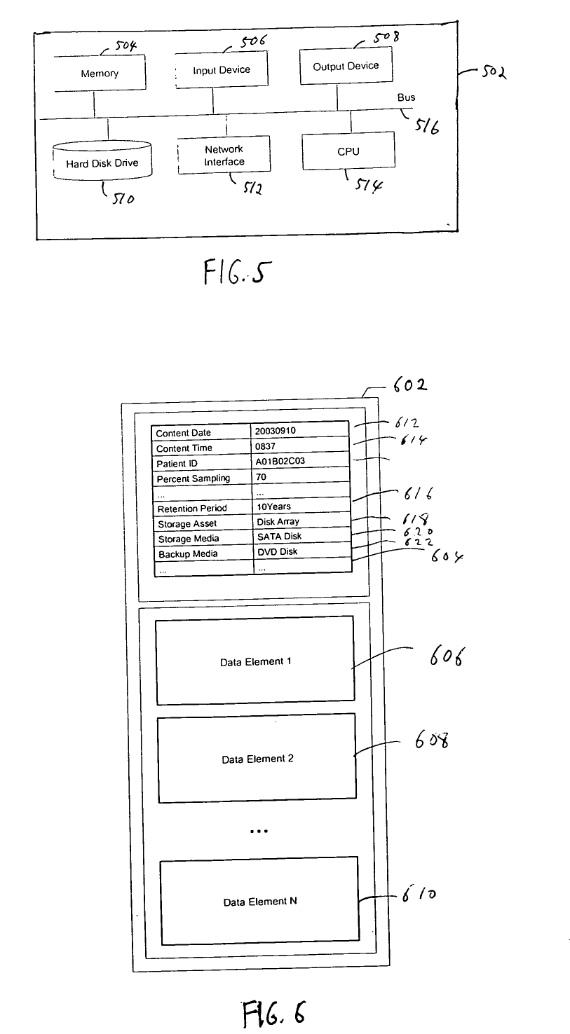

FIG. 5 illustrates an exemplary computer system 502 that may represent the client 402, host 404, data protection server 408, and data relocation server 410. The computer system 502 includes a memory 504, an input device 506, an output device 508, a hard disk drive 510, a network interface 512, a central processing unit 514, and a bus 516 coupling the above components. Accordingly, the computer system 502 is a general purpose personal computer in one embodiment of the present invention.

FIG. 6 illustrates the data structure of a data file 602 according to one embodiment of the present invention. The data file 602 includes a header 604 and one or more data elements 606, 608, and 610. The header 604 includes the administrative information for the data elements. One example of the data file 602 is a data file that has a format that is similar to the DICOM standard format, as described by the American College of Radiology (ACR) and National Manufacturers Association (NEMA) in PS3.10 specification, “Media Storage and File Format Interchange.” A multiple application data, e.g., CT scan images, can be stored in a single data file. The DICOM data file includes a header that contains various types of data attributes. Another example of the data file 602 is a data file that has multipart MIME data format configured to store multiple text data into a single data file.

In the present embodiment, the data management rules, including retention and relocation information, are inserted into the header 604 of the data file 602. For example, the header 604 includes a content date field 612, a content time field 614, a retention period field 616, a storage asset field 618, a storage media field 620, and a backup media field 622.

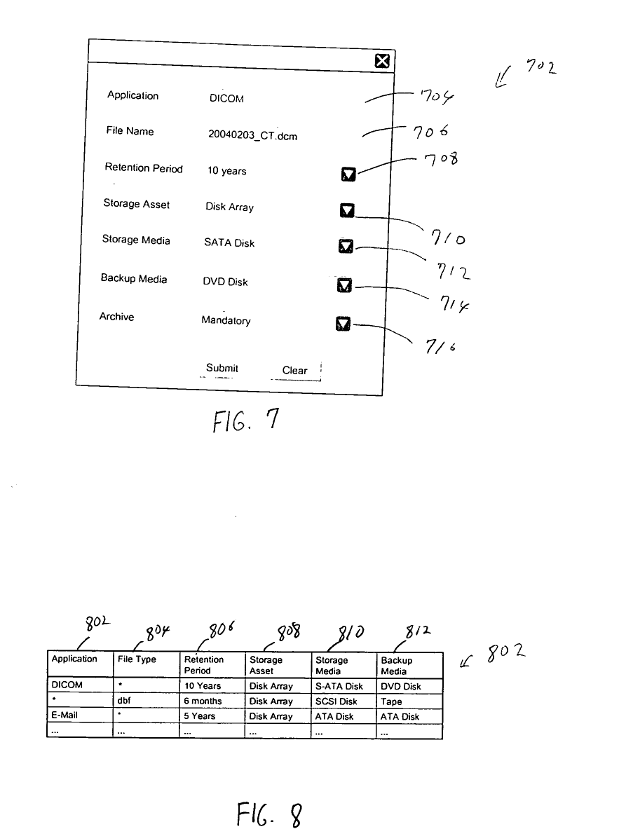

FIG. 7 illustrates a graphical user interface (GUI) 702 provided by the data management rule set GUI 426 according to one embodiment of the present invention. A data administrator may use the GUI to set or input the data management rule for data files created by the data production application program 424. The GUI includes an application section 704 to specify the application associated with the data (e.g., the data type or format), a file name section 706 to provide the file with a name, a retention period section 708 to specify the retention period for the data file, a storage asset section 710 to specify the type of storage subsystem wherein the file is to be stored, a storage media section 712 to specify the type storage media whereon the data file is to be stored, a backup media section 714 to specify the type of backup media to be used, and an archive section 716 to specify how the data file is to be archived. The inputs made on the above sections are reflected on the header 604 of the data file 602.

FIG. 8 illustrates a table 800 that corresponds to the data management rule information 430 according to one embodiment of the present invention. The data management rules that an administrator input are stored in the table 800. The table 800 includes an application field 802, a file type field 804, a retention period field 806, a storage asset field 808, a storage media field 810, and a backup media field 812.

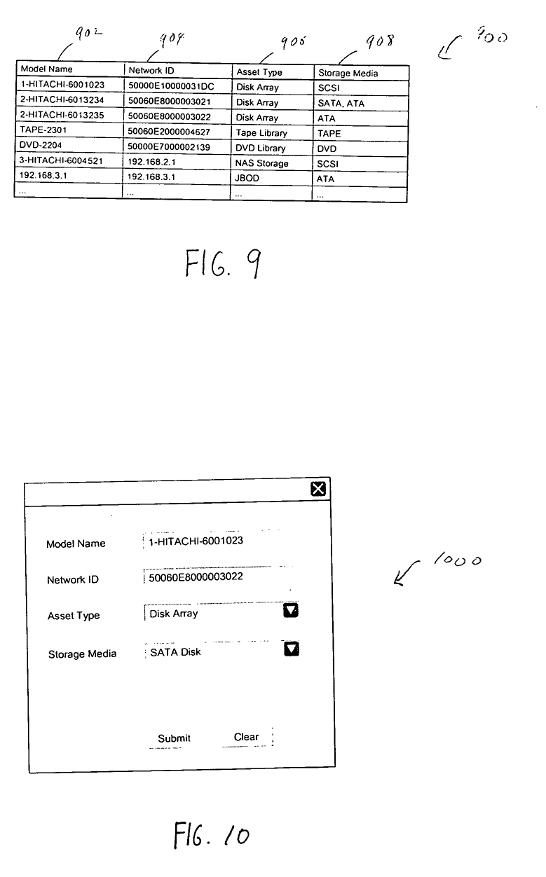

FIG. 9 illustrates a table 900 corresponding to the storage information table 446 according to one embodiment of the present invention. The table includes a model name field 902 indicates the name of the storage device, a network ID field 904 indicates a network address of the storage device (e.g., Word Wide Name in Fibre Channel), an asset type field 906 indicates the type of storage device, and a storage media field 908 indicates the type of storage media installed in the storage device. In one implementation, the data relocation server 410 stores a list of storage devices installed in the storage system 400 in the table 900. The table may be updated manually by administrators or the storage information management program 448 may automatically discover the installed storage devices by using a SNMP protocol or SNIA SMI-S standard framework.

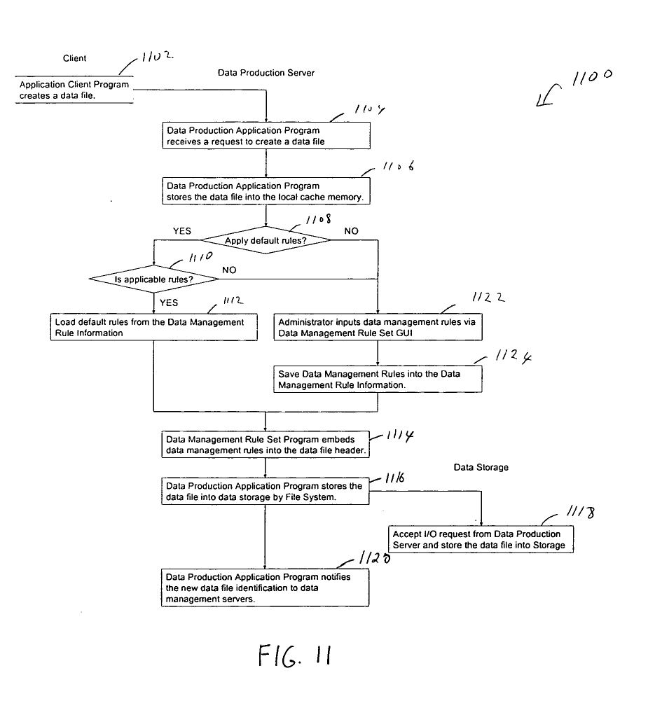

FIG. 10 illustrates a user interface 1000 for obtaining the table 900 according to one embodiment of the present invention. The interface 1000 is provided by the storage information set GUI 450. An administrators generates the table 900 using the interface 1000 according to one embodiment of the present invention. Alternatively, the data relocation server 410 automatically discovers the storage assets using a SNMP mechanism.

FIG. 11 illustrates a process 1100 for creating an application data file according to one embodiment of the present invention. At step 1102, the application client program 422 sends an I/O request to the data production application program 424 in order to create a new data file or modify an existing data file. The data production application program 424 receives the I/O request (step 1104). The program 424 accepts the I/O request and creates a new data file (step 1106). The data file received from the client is stored in the temporary cache memory while the new data file is being created. The new data file is provided with management rules, which are inserted into the header of the data file received from the client.

The process checks to determine whether or not there are default rules for the data file received from the client (step 1108). In one embodiment, default rules are assigned to predetermined applications, so that the data files associated with these applications may be automatically assigned the default rules. The default rules are stored in the data management rule information 430 in the present embodiment. For example, a DICOM data file may be provided with the following default rules: the retention period is 10 years, storage asset is disk array, storage media is SATA disk, and backup media is DVD disk, etc.

If there is applicable default rules for the data file received the client, the default rules are loaded or retrieved from the data management rule information (step 1112). In the DICOM data file, the client is CT equipment. The data management rule set program 428 embeds the default management rules into the header of the data file received (step 1114). The header 604 of the data file 602 in FIG. 6 illustrates the default rules embedded therein.

The data production application program 424 sends the first storage subsystem 406-1 using the file system 432 (step 1116). The subsystem 406-1 receives the write request from the host 404 and stores the data file with its header in a storage volume, e.g., storage media 434 (step 1118). The data production application program 424 notifies the data protection server 408 and data relocation server 410 of the new data file stored in the subsystem 406-1 (step 1120).

Referring back to step 1108, if applicable default rules do not exist for the data file received from the client, the administrator inputs the management rules using the data management rule set GUI 426 (step 1122). The management rules are stored in the data management rule information 430 (step 1124) Thereafter, the rules are stored in the header of the data file, and the data file is stored in the subsystem 406-1.

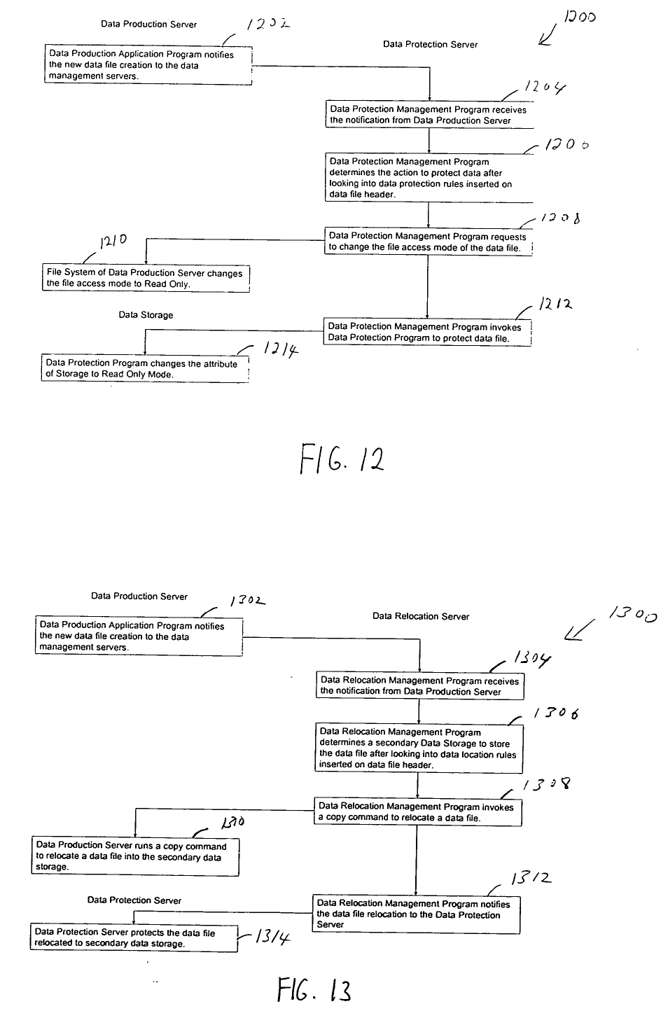

FIG. 12 illustrates a process 1200 performed by the data protection server 208 according to one embodiment of the present invention. At step 1202, the data protection application program 424 of the host 404 sends a message to the data protection server 408 notifying the storage of the new data file in the first subsystem 406-1. This step corresponds to step 1120 of the process 1100. The data protection management program 442 receives the notification (step 1204). The data protection management program 442 determines actions that need to be performed to protect the data (step 1206). For example, the program 442 looks up the retention period parameter inserted in the data file header to determine how long the data file is locked from being overwritten.

The data protection management program 408 sends a request to the file system 432 in the host to change the file access mode of the data file (step 1208). The file system 408 changes the file access mode to READ ONLY (step 1210).

The data protection management program also invokes the data protection program 436 in the first subsystem 406-1 wherein the data file was stored (step 1212). The data protection program 436 changes the attribute of a storage area to READ ONLY from READ/WRITE to protect the data file (step 1214). In one implementation, the file access mode of the data file is modified using the data protection management program 408 rather than the data protection program in the subsystem.

FIG. 13 is a process 1300 for relocating data files according to one embodiment of the present invention. The process is triggered by data production application which creates the data file and appends data relocation rules. The data production application program 424 sends a notification message to the data relocation server 410 of the new data file stored in the first subsystem 406-1 (step 1302). This step corresponds to the step 1120 of the process 1100. The data relocation management program 444 receives the notification (step 1304). The program 444 looks up the management rules relating to data storage location rules in the header of the data file (step 1306). For example, the storage asset field 618 and storage media field 620 of the header 604 are looked up to determine the types of storage device and media indicated as being suitable for storing the data file. In one implementation, the data relocation management program 444 send a request to the host 404 for an issuance of a copy command to relocate the data file. This copy command may be a conventional copy command.

The host 404 issues a copy command to relocate the data file stored in the storage volume 434 of the first subsystem 406-1 to the storage volume 438 of the second storage subsystem 406-2 (step 1310). The data relocation management program 444 notifies the data protection server 408 of the relocation of the data file to the storage volume 438 (step 1312). The data protection server 408 protects the data file that has been relocated to the storage volume 438, e.g., changing the access mode to READ ONLY from READ/WRITE (step 1314).

The present invention has been described in terms of specific embodiments. The illustrated embodiments may be modified, altered, or changed without departing from the scope of the present invention. The scope of the present invention should be determined using the appended claims.

1. A storage system, comprising:
a host configured to receive a data file from a client, the host including a data management rule set program that is operable to associate a management rule to the data file received from the client;
a first storage subsystem configured to receive and store the data file from the host, the storage system including a storage controller and a plurality of storage volumes; and
a data protection server including a data protection management program that cooperates with the first storage subsystem to protect the data file stored in the first storage subsystem.

2. The storage system of claim 1, wherein the management rule is inserted into a header of the data file.

3. The storage system of claim 2, wherein the management rule relates to a retention period of the data file.

4. The storage system of claim 1, wherein the first storage subsystem further comprises a data protection program that cooperates with the data protection management program of the data protection server to protect the data file stored in the first storage subsystem, wherein the management rule is attached to the data file and transmitted to the first storage subsystem with a data content of the data file.

5. The storage system of claim 1, where the data file is stored in a first storage volume of the first storage subsystem, the storage system further comprising:
a data relocation server configured to manage relocation of the data file to a second storage volume from the first storage volume, the data relocation server including a data relocation management program and a storage information table including information about storage subsystems and storage media associated with the storage system, wherein the data relocation management program initiates the relocation of the data file to the second storage volume by looking up the storage information table for a suitable storage location for the second storage volume.

6. The storage system of claim 5, wherein the second storage volume is located in a second storage subsystem of the storage system.

7. The storage system of claim 1, wherein the data relocation server and the host are different devices.

8. The storage system of claim 1, wherein the data protection server and the host are different devices.

9. The storage system of claim 1, wherein the data management rule set program of the host inserts a plurality of management rules into a header of the data file, the management rules relating to information about a retention period and relocation instructions of the data file.

10. A management server provided in a storage system, the storage system including one or more hosts and one or more storage subsystems, the management server comprising:
a memory to store data;
a processor to process data;
a network interface to link with one or more computers of the storage system;
a first management program to attach a management rule to a data file to be stored in a storage subsystem of the storage system, the management rule relating to a retention period or relocation information of the data file,
wherein the data file and the management rule are stored in a storage volume of the storage subsystem.

11. The server of claim 10, wherein the server is a host that is configured to receive data files from a client of the storage system and send read and write requests to the storage subsystem.

12. The server of claim 10, wherein the management rule is inserted into a header of the data file, the server further comprising:
a second management program that cooperates with a file system to store the data file in the storage subsystem.

13. A management server provided in a storage system, the storage system including one or more hosts and one or more storage subsystems, the management server comprising:
a memory to store data;
a processor to process data;
a network interface to link with one or more computers of the storage system;
a first management program operable to access a header of a data file and manage the data file according to a management rule inserted in the header, the management rule relating to a retention period or relocation instructions of the data file.

14. The server of claim 13, wherein the server is a data protection server and the first management program is a data protection management program.

15. The server of claim 13, wherein the server is a data relocation server and the first management program is a data relocation management program.

16. A method for managing a data file stored in a storage system, the storage system including one or more client, one or more hosts, one or more storage subsystems, the method comprising:
receiving a data file including a header and a data content;
attaching a management rule to the data file;
storing the data file and the management rule at a first storage location in a first storage subsystem, the management rule relating to retention or relocation information of the data file; and
notifying a management program about the data file.

17. The method of claim 16, further comprising:
accessing the management rule attached to the data file; and
performing a management act relating to the data file according to the management rule,
wherein the management rule is inserted into a header of the data file.

18. The method of claim 17, wherein the management rule is accessed by a data protection management program provided in a data protection server, the management act being an act related to preventing the data file stored in the first storage location from being modified or deleted.

19. The method of claim 17, wherein the management rule is accessed by a data relocation server, and the management act relates to relocating the data file to a second storage location.

20. The method of claim 1, wherein the management rule is inserted into a header of the data file by a host.
